(19) United States
(12) Patent Application Publication
(10) Pub. No.: US 2014/0267184 A1
(43) Pub. Date: Sep. 18, 2014

(54) Multimode Stylus

(71) Applicant: ELWHA LLC, Bellevue, WA (US)

(72) Inventors: Steven Bathiche, Kirkland, WA (US); Jesse R. Cheatham, III, Seattle, WA (US); Paul H. Dietz, Redmond, WA (US); Matthew G. Dyor, Bellevue, WA (US); Philip A. Eckhoff, Bellevue, WA (US); Anoop Gupta, Woodinville, WA (US); Kenneth P. Hinckley, Redmond, WA (US); Roderick A. Hyde, Redmond, WA (US); Muriel Y. Ishikawa, Livermore, CA (US); Jordin T. Kare, Seattle, WA (US); Craig J. Mundie, Seattle, WA (US); Nathan P. Myhrvold, Medina, WA (US); Andreas G. Nowatzyk, San Jose, CA (US); Robert C. Petroski, Seattle, WA (US); Danny Allen Reed, Iowa City, IA (US); Clarence T. Tegreene, Mercer Island, WA (US); Charles Whitmer, North Bend, WA (US); Lowell L. Wood, JR., Bellevue, WA (US); Victoria Y.H. Wood, Livermore, CA (US)

(73) Assignee: ELWHA LLC, Bellevue, WA (US)

(21) Appl. No.: 13/828,289

(22) Filed: Mar. 14, 2013

(51) Int. Cl. G06F 3/0354

(52) U.S. Cl. CPC G06F 3/03545
USPC 345/179

(57) ABSTRACT

A stylus for use as an input device automatically switches its mode of operation.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

None.

### RELATED APPLICATIONS

None.

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, an input device includes a stylus configured to be grasped and having a working tip, and a switch configured to automatically switch the stylus between and first coordinate determining mode and a second coordinate determining mode in response to a condition. The stylus is configured to emit a first signal during the first coordinate determining mode, and may be configured to emit a second signal during the second coordinate determining mode. The condition may be selected from the group consisting of distance between the working tip and a surface, contact of the working tip with a surface, pressure of the working tip against a surface, strength of a signal from a digitizer, signal-to-noise ratio of a signal from a digitizer, strength of a signal to a digitizer, signal-to-noise ratio of a signal to a digitizer, orientation of the stylus relative to a digitizer, attitude of the stylus relative to a gravitational field, acceleration history of the stylus, position of a hand holding the stylus, error rate in determining stylus position, orientation, or state, and noise level in determining stylus position or orientation. The switch may be integral to the stylus, or may be integrated into a digitizer device configured to be operated by the stylus, or it may be further configured to switch the stylus into a third, sleep mode. The input device may further include an indicator configured to indicate a condition of the stylus. The stylus may not emit a signal during the second coordinate determining mode, may use less power during that mode, or may use a different form or format. The first signal may be, for example, optical, RF, ultrasonic, acoustic, or low frequency electromagnetic, and may encode data usable to determine the position, orientation, or state of the stylus. The input device may further include a manual switch, for example a switch configured to shift the stylus into a particular mode or to lock the stylus in a particular mode.

In another aspect, a method of inputting data into a device having an input surface includes bringing a working tip of the stylus near the input surface while it operates in a first coordinate determining mode, and, in response to a condition, switching the stylus to a second coordinate determining mode. During at least one of the coordinate determining modes, the stylus emits a signal that the device is configured to interpret (e.g., an optical signal, an RF signal, an ultrasonic signal, an acoustic signal, or a low-frequency magnetic signal). The condition may be selected from the group consisting of distance between the working tip and the input surface, contact of the working tip with the input surface, pressure of the working tip against the input surface, strength of a signal from the device, signal-to-noise ratio of a signal from the device, strength of a signal to the device, signal-to-noise ratio of a signal to the device, orientation of the stylus relative to the device, attitude of the stylus relative to a gravitational field, acceleration history of the stylus, position of a hand holding the stylus, error rate in determining stylus position, orientation, or state, and noise level in determining stylus position or orientation, and may include the position of a manual switch. In one of the coordinate determining modes, the stylus may use less power or not emit a signal at all. In the first and second coordinate determining modes, the stylus may emit signals having different forms or different formats. The stylus may emit a signal encoding data usable to determine the position, orientation, or state of the stylus, and the method may further include using the encoded data to alter a state of the device. The method may further comprise switching the stylus into a sleep mode. The device may operate at a different resolution in the first coordinate determining mode and the second coordinate determining mode.

In still another aspect, a method of operating a manual computer input device includes operating the device in a first signaling mode, sensing a change in a condition, and, in response to the sensed change, operating the device in a different, second signaling mode, wherein at least one of the signaling modes is a powered mode. The condition may be selected from the group consisting of distance between a working tip and an input surface, contact of a working tip with an input surface, pressure of a working tip against an input surface, strength of a signal from the device, signal-to-noise ratio of a signal from the device, strength of a signal to the device, signal-to-noise ratio of a signal to the device, orientation of the device relative to an input surface, attitude of the device relative to a gravitational field, acceleration history of the device, position of a hand holding the device, error rate in determining device position, orientation, or state, and noise level in determining device position or orientation, and may include the position of a manual switch. During one of the signaling modes, the device may use less power or may not emit a signal at all. The device may emit signals having different forms or different formats during the first and second signaling modes, or may operate at different resolutions in the two modes. During at least one signaling mode, the device may emit a signal such as an optical signal, an RF signal, an ultrasonic signal, an acoustic signal, or a low-frequency magnetic signal, and the signal may encode data usable to determine the position, orientation, or state of the device. The method may further include using this encoded data to alter a state of the device, or it may further include switching the device into a sleep mode.

In yet another aspect, an electronic device includes a first receiver configured to receive a first signal from a stylus indicating its status, a sensor configured to identify a location or attitude of the stylus, and a display responsive to the first receiver and to the sensor and configured to display information relating to the status, location, or attitude of the stylus. The device may further include a transmitter configured to toggle the stylus on or off. The device may further include a switch configured to use the sensor to determine that the stylus is close enough to the device to operate without the first signal and to respond to that determination by communicating a directive to the stylus to cease transmitting the first signal. The device may include a switch configured to respond to a condition by transmitting a directive to the stylus to alter the first signal, where the condition may be selected from the group consisting of distance between the working tip and a surface, contact of the working tip with a surface, pressure of the working tip against a surface, strength of a signal from a digitizer, signal-to-noise ratio of a signal from a digitizer, strength of a signal to a digitizer, signal-to-noise ratio of a signal to a digitizer, orientation of the stylus relative to a digitizer, attitude of the stylus relative to a gravitational field, acceleration history of the stylus, position of a hand holding the stylus, error rate in determining stylus position, orientation, or state, and noise level in determining stylus position or orientation, and the directive may be, for example, a direction to stop transmitting the first signal or to transmit a different signal. The received signal may be an optical signal, an RF signal, an ultrasonic signal, an acoustic signal, or a low-frequency magnetic signal. The device may further include a manual switch, which could be configured to direct the stylus to shift to a selected mode or to stop transmitting the first signal. The device may further include an indicator configured to display information about the current state of the stylus. The device may further include a second receiver configured to receive a second signal from the stylus having a different form or format, or the first receiver may be configured to receive such a second signal.

In yet still another aspect, a method of receiving information from a stylus includes receiving a first signal indicating a status of the stylus (e.g., its position or attitude), determining a condition of the stylus, and responding to the determined condition by directing the stylus to alter the first signal (e.g., an optical signal, an RF signal, an ultrasonic signal, an acoustic signal, or a low-frequency magnetic signal). The condition may be selected from a group consisting of distance between the working tip and a surface, contact of the working tip with a surface, pressure of the working tip against a surface, strength of a signal from a digitizer, signal-to-noise ratio of a signal from a digitizer, strength of a signal to a digitizer, signal-to-noise ratio of a signal to a digitizer, orientation of the stylus relative to a digitizer, attitude of the stylus relative to a gravitational field, acceleration history of the stylus, position of a hand holding the stylus, error rate in determining stylus position, orientation, or state, and noise level in determining stylus position or orientation. Directing the stylus to alter the first signal may include directing it to stop transmitting the first signal, or directing it to transmit a different, second signal. The method may include receiving a second signal having a different form or format from the first signal.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a schematic of a stylus for use with a touch-screen.

FIG. 2A illustrates a first grip position for a stylus.

FIG. 2B illustrates a second grip position for the stylus.

FIG. 3 is a schematic of a tablet usable with the stylus of FIG. 1.

FIG. 4 is a flow chart illustrating operation of a stylus.

FIG. 5 is a flow chart illustrating operation of a receiver.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Pen-based electronic devices such as personal tablet computers have grown in popularity in recent years. While these devices are often operated by using a finger to “draw” on the screen, for some applications, a stylus offers superior control or other advantages. A stylus may be passive, working simply by contact or electrical interaction with a drawing surface without the need for powered operation, or it may be active, emitting a signal to indicate its position or other state information. U.S. Pat. No. 5,396,443, which is incorporated herein by reference to the extent not inconsistent herewith, describes a stylus configured to automatically switch to a power-saving “standby” mode when not in use. The stylus senses when the user has touched its housing to switch to powered mode, and includes a time that switches the stylus back to standby mode a fixed period after it is no longer in contact with the user. That stylus has two modes: a powered mode for when the stylus is in use, and a power-saving standby mode in which the stylus cannot be used as an input device.

FIG. 1 shows a stylus 100 configured to operate in multiple modes, including both an unpowered and a powered coordinate determining input mode. The illustrated stylus includes a working tip 102 configured to passively operate a touch-screen device, for example by using capacitive sensing. When tip 102 is brought into proximity or contact with a receiver device (see FIG. 3 below), it operates as a standard unpowered stylus, wherein the receiver device determines the coordinates of the stylus tip in order to communicate with the device. However, when tip 102 is farther away from a receiver device, powered transmitter 104 is engaged to transmit data to the device. Transmitter 104 may be, for example, electromagnetic (e.g., a radio frequency transmitter or an optical transmitter) or acoustic (e.g., an ultrasound transmitter). Data transmitted may be the position (coordinates) of the stylus 100 (as it is during unpowered operation), or it may transmit other information such as its orientation relative to the receiver device, its attitude relative to a gravitational field, or the grip of the user of the stylus 100. The illustrated stylus has an optional display 106 indicating whether it is operating in a powered mode or a passive mode. In some embodiments, this information may be displayed on the receiver device, or may not be displayed. Display 106 may also include information on available battery life or other relevant operating information.

For the illustrated stylus 100, switching between powered and unpowered coordinate determining modes is automatic and based on proximity to the receiver device. Sensor 108 is configured to monitor the distance between the stylus 100 and the receiver and to switch the stylus to powered mode if it moves into a region where the unpowered mode is unreliable, inaccurate, or otherwise unsatisfactory for data entry. Sensor 108 (or other, similar components of the stylus or of the receiver device) may optionally also switch off the power if the stylus is not being used. In other embodiments, stylus 100 may include a contact sensor at working tip 102 that switches off powered operation when the tip 102 is in contact with a receiver. In some embodiments, sensor 108 is a receiver that receives a signal sent by the receiver device. In some embodiments, sensor 108 is a contact or pressure sensor that determines whether the stylus is in contact with the receiver device.

The illustrated stylus 100 also includes sensors 110 configured to monitor the grip that the user is using with the stylus. Users may naturally shift their grip on the stylus as it is used for different types of input, for example holding it closer to tip 102 when drawing a picture than when writing a word. By monitoring sensors 110, the stylus can respond to these changes, for example by changing the resolution of the receiver device. Sensors 110 may be configured to exploit “natural” shifts in stylus grip like these, or may be arranged so that users can consciously change the operation of the stylus by changing their grip. For example, in some embodiments, if the stylus 100 is used to input into a drawing program, it may function as a “pencil” when held near the tip, drawing solid lines (as illustrated in FIG. 2A), and as a “spray paint” or “brush” when held in a “wand” type configuration (as illustrated in FIG. 2B).

U.S. Pat. No. 8,139,049, which is incorporated herein by reference to the extent not inconsistent herewith, describes an integrated stylus/scanner which may be used either to scan images or to function as a stylus, but it does not use cues of distance or orientation to switch modes—one end is the stylus, and the other end is the scanner. In contrast, the illustrated stylus 100 functions as a conventional stylus when it is in contact with the receiver, and may either continue to function like a stylus when it is not in contact with the receiver, or may be used as a “wand” or in another configuration atypical of a conventional stylus.

When stylus 100 is in a powered signaling mode, it may use any of a variety of signal forms or signal formats. Signal forms may include, but are not limited to, electromagnetic signals such as optical signals, RF signals, low frequency electromagnetic signals (e.g., inductive or near-field signals), or static or quasistatic magnetic fields, acoustic signals such as ultrasonic signals, or thermal signals (e.g., a stylus with a “hot” spot to simulate contact with a finger). Signal formats may include analog modulation of amplitude, frequency, or phase, analog pulse rate or pulse width modulation, or digitally encoded signals (using any convenient encoding, for example serial ASCII text, serial binary or BCD numerical data, or IP data packets). Signal formats may differ in the type of modulation or in another characteristic such as pulse rate (e.g., for a pulse width modulated signal) or bit rate (e.g., for a digitally encoded signal). For example, a low-bit-rate and a high-bit-rate signal, both using frequency-shift keying (a form of frequency modulation) may be considered two different formats. In some embodiments, stylus 100 may automatically switch between different signal forms and/or different signal formats, using rules similar to those described above for switching between powered and unpowered operation. For example, when a signal-to-noise ratio falls to an unacceptable level during pulsed operation, stylus 100 may switch to a continuous signal format.

The illustrated stylus 100 also includes a button 112 configured to shift the mode of the stylus, for example to “lock” it in a powered mode. (This function can also be provided in software, as shown below in connection with FIG. 3.) The button may, for example, function as an override to force use of a powered mode, or it may shift stylus 100 to powered mode for a short time after it is pressed, and then automatically revert to automatic switching as described above.

FIG. 3 shows a tablet 200 usable with the stylus 100 shown in FIG. 1. The tablet includes a touch screen 202 which is responsive to stylus 100, and optionally also to contact with the user's fingers or with other input devices. The tablet 200 includes an internal transmitter 204 and receiver 206, shown schematically in FIG. 3, but some embodiments may include only receiver 206, or may combine these components into a single element that may both transmit and receive. In use, transmitter 204 and receiver 206 communicate with transmitter 104 and receiver 108 in stylus 100 to monitor distance, orientation, relative orientation of the devices, attitude of the devices, or acceleration history of the devices. Any of these conditions may be used as part or all of the criteria for toggling the stylus between operating modes, as may error rate, signal-to-noise ratio, or signal strength. For example, when the error rate in receiving a signal from stylus 100 at tablet 200 rises above a predetermined threshold, the tablet may signal the stylus that it should shift to a powered mode. In another example, when the signal strength from stylus 100 rises above a threshold, or when the acceleration history of stylus 100 indicates that it is being brought toward tablet 200 in a “writing” position, tablet 200 may direct stylus 100 to shift into an unpowered mode. Other combinations of data between the two devices that may be used as toggle conditions will be readily apparent to those of ordinary skill in the art. For example, when stylus velocity and tip force are consistently high-or-zero (indicating use as a mouse-like pointer), or when using an application that does not include a drawing function, the stylus may switch to a low-power low-accuracy mode. When velocity is low and force is variable (indicating use as a drawing tool or similar precision application), or when stylus tip is in an application and screen area having a drawing-input function, switch to a high-power high accuracy mode.

The illustration in FIG. 3 shows a “setup” screen where the user may toggle certain settings for the stylus. It will be understood that the depicted settings are illustrative, and that other settings may be appropriate for different embodiments of the stylus 100 or the tablet 200 within the scope and spirit of the invention. Setting 220, “Keep stylus powered,” overrides the toggling described above, maintaining the stylus in a powered mode during use. This setting might be desirable if the user wants to avoid frequent mode-switching of the stylus during intensive use, or if battery life is not a concern and the user wants to maintain high signal strength. A similar setting, not shown in FIG. 3, might allow a user to disable powered operation of the stylus 100, or lock it into using a particular form or format of the signal as discussed further below.

Setting 222, “Respond to input from stylus only,” disables tablet 200 from responding to the user's fingers instead of the stylus. This setting is shown as being manually set, but it could also be toggled in the same fashion as the powered mode described above. For example, tablet 200 might be responsive to finger touches if stylus 100 is more than a couple of inches away from the surface, but might be responsive only to the stylus when it is in closer proximity to the tablet. In such a configuration, the user may seamlessly switch between using stylus 100 for fine work and using fingers for casual input or multi-touch operation.

Setting 224, “Enable grip sensors for mode switching,” allows stylus 100 to use a different signal form, signal format, or signal content when grip sensors 110 indicate that a user has shifted his grip on stylus 100. For example, stylus 100 might explicitly signal that the user's hand is no longer in contact with sensors 110, or it might shift to a signal form suitable for longer range operation when it appears that the user intends to use it as a “wand,” as discussed above. In some embodiments, this option might be switched off by a user who is annoyed by the mode shift or who does not use a standard grip on stylus 100 that is accurately interpreted by sensors 110. Similar settings (not shown) might be used to enable or disable “wand” mode entirely, or to restrict it to certain applications.

Setting 226, “Time until sleep mode,” allows a user to specify that stylus 100 will enter an unpowered mode after a period of inactivity of the stylus. This setting prevents the stylus from draining the battery if it is left too close to the receiver, for example.

FIG. 4 is a flow chart illustrating operation of a stylus such as that shown in FIG. 1. The stylus starts out in a first coordinate-determining mode 302 (for example, in a powered mode in which it transmits coordinate and attitude information electronically). If it (or a receiving device) determines that “Condition1” 304 exists (for example, that it is contacting a touch screen), then it moves to a second coordinate-determining mode 306 (for example, an unpowered capacitive sensing move). If “Condition1” does not exist, it remains in the first mode 302. Once the device has shifted to the second coordinate-determining mode 306, it monitors for “Condition2” 308 (for example, that the stylus is no longer contacting the touch screen). If “Condition2” applies, it shifts back to the first mode 302; if not, it remains in the second mode 306. In the example described, “Condition1” and “Condition2” are mirror images of one another, but this need not necessarily be the case. For example, a stylus might shift into unpowered mode on the basis of signal strength, but back into powered mode on the basis of noise level. When the conditions do not mirror one another, those of ordinary skill in the art will understand that provision must be made to avoid unnecessary oscillation between states, and will provide appropriate circuitry or software to accomplish this.

FIG. 5 is a flow chart illustrating operation of a receiving device with a stylus. The receiving device receives a signal 350 from the stylus. For example, the signal may provide coordinates for the stylus. It then determines whether a condition 352 exists. For example, it may determine that the stylus is moving away from the receiver. If the condition exists, the receiver directs the stylus to alter the first signal 354. For example, the receiver may directly the stylus to shift to a powered mode or to a higher power level before it moves too far away from the receiver to provide a reliable signal.

It will be understood that, in general, terms used herein, and especially in the appended claims, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood that if a specific number of an introduced claim recitation is intended, such an intent will be explicitly recited in the claim, and in the absence of such recitation no such intent is present. For example, as an aid to understanding, the following appended claims may contain usage of introductory phrases such as “at least one” or “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a receiver” should typically be interpreted to mean “at least one receiver”); the same holds true for the use of definite articles used to introduce claim recitations. In addition, even if a specific number of an introduced claim recitation is explicitly recited, it will be recognized that such recitation should typically be interpreted to mean at least the recited number (e.g., the bare recitation of “two receivers,” or “a plurality of receivers,” without other modifiers, typically means at least two receivers). Furthermore, in those instances where a phrase such as “at least one of A, B, and C,” “at least one of A, B, or C,” or “an [item] selected from the group consisting of A, B, and C,” is used, in general such a construction is intended to be disjunctive (e.g., any of these phrases would include but not be limited to systems that have A alone, B alone, C alone, A and B together, A and C together, B and C together, or A, B, and C together, and may further include more than one of A, B, or C, such as A₁, A₂, and C together, A, B₁, B₂, C₁, and C₂ together, or B₁ and B₂ together). It will be further understood that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An input device, comprising:
a stylus configured to be grasped and having a working tip; and
a switch configured to automatically switch the stylus between a first coordinate determining mode and a second coordinate determining mode in response to a condition, wherein the stylus is configured to emit a first signal during the first coordinate determining mode.

2. The input device of claim 1, wherein the condition is selected from the group consisting of:
distance between the working tip and a surface;
contact of the working tip with a surface;
pressure of the working tip against a surface;
strength of a signal from a digitizer;
signal-to-noise ratio of a signal from a digitizer;
strength of a signal to a digitizer;
signal-to-noise ratio of a signal to a digitizer;
orientation of the stylus relative to a digitizer;
attitude of the stylus relative to a gravitational field;
acceleration history of the stylus;
position of a hand holding the stylus;
error rate in determining stylus position, orientation, or state; and
noise level in determining stylus position or orientation.

3. The input device of claim 1, wherein the stylus does not emit a signal during the second coordinate determining mode.

4. The input device of claim 1, wherein the stylus uses less power during the second coordinate determining mode.

5. The input device of claim 1, wherein the stylus is configured to emit a second signal in a different form during the second coordinate determining mode from the first signal.

6. The input device of claim 1, wherein the stylus is configured to emit a second signal in a different format during the second coordinate determining mode from the first signal.

7. The input device of claim 1, wherein the first signal is optical.

8. The input device of claim 1, wherein the first signal is RF.

9. The input device of claim 1, wherein the first signal is ultrasonic.

10. The input device of claim 1, wherein the first signal is acoustic.

11. The input device of claim 1, wherein the first signal is low frequency electromagnetic.

12. The input device of claim 1, wherein the first signal encodes data usable to determine the position, orientation, or state of the stylus.

13. The input device of claim 1, further comprising a manual switch configured to shift the stylus into the first coordinate determining mode or the second coordinate determining mode.

14. The input device of claim 1, further comprising a manual switch configured to lock the stylus into the first coordinate determining mode or the second coordinate determining mode.

15. The input device of claim 1, wherein the switch is integral to the stylus.

16. The input device of claim 1, wherein the switch is integrated into a digitizer device configured to be operated by the stylus.

17. The input device of claim 1, further comprising an indicator configured to indicate the current coordinate determining mode of the stylus.

18. The input device of claim 1, wherein the switch is further configured to switch the stylus into a third sleep mode.

19. A method of inputting data into a device having an input surface, the method comprising:
bringing a working tip of a stylus near the input surface, the stylus operating in a first coordinate determining mode; and
in response to a condition, switching the stylus to a second coordinate determining mode,
wherein during at least one of the coordinate determining modes, the stylus emits a signal that the device is configured to interpret.

20. The method of claim 19, wherein the condition is selected from the group consisting of:
distance between the working tip and the input surface;
contact of the working tip with the input surface;
pressure of the working tip against the input surface;
strength of a signal from the device;
signal-to-noise ratio of a signal from the device;
strength of a signal to the device;
signal-to-noise ratio of a signal to the device;
orientation of the stylus relative to the device;
attitude of the stylus relative to a gravitational field;
acceleration history of the stylus;
position of a hand holding the stylus;
error rate in determining stylus position, orientation, or state; and
noise level in determining stylus position or orientation.

21. The method of claim 19, wherein the condition includes the position of a manual switch.

22.-30. (canceled)

31. The method of claim 19, wherein the stylus emits a signal encoding data usable to determine the position, orientation, or state of the stylus.

32. The method of claim 31, further comprising using the encoded data to alter a state of the device.

33. The method of claim 19, further comprising switching the stylus into a sleep mode.

34. The method of claim 19, wherein the device operates at a different resolution during the first coordinate determining mode and the second coordinate determining mode.

35. A method of operating a manual computer input device, the method comprising:
operating the device in a first signaling mode;
sensing a change in a condition; and
in response to the sensed change, operating the device in a second signaling mode different from the first signaling mode, wherein at least one of the first signaling mode and the second signaling mode is a powered mode.

36.-50. (canceled)

51. An electronic device, comprising:
a first receiver configured to receive a first signal from a stylus indicating a status of the stylus;
a sensor configured to identify a location or attitude of the stylus; and
a display responsive to the first receiver and to the sensor configured to display information relating to the status, location, or attitude of the stylus.

52. The device of claim 51, further comprising a transmitter configured to toggle the stylus signal on or off.

53. The device of claim 51, further comprising a switch configured to use the sensor to determine that the stylus is close enough to the device to operate without the first signal and to respond to that determination by communicating a directive to the stylus to cease transmitting the first signal.

54. The device of claim 51, further comprising a switch configured to respond to a condition by transmitting a directive to the stylus to alter the first signal, wherein the condition is selected from the group consisting of:
distance between the working tip and a surface;
contact of the working tip with a surface;
pressure of the working tip against a surface;
strength of a signal from a digitizer;
signal-to-noise ratio of a signal from a digitizer;
strength of a signal to a digitizer;
signal-to-noise ratio of a signal to a digitizer;
orientation of the stylus relative to a digitizer;
attitude of the stylus relative to a gravitational field;
acceleration history of the stylus;
position of a hand holding the stylus;
error rate in determining stylus position, orientation, or state; and
noise level in determining stylus position or orientation.

55. The device of claim 54, wherein transmitting a directive to the stylus to alter the first signal includes directing the stylus to stop transmitting the first signal.

56. The device of claim 54, wherein transmitting a directive to the stylus to alter the first signal includes directing the stylus to transmit a different signal.

57.-61. (canceled)

62. The device of claim 51, further comprising a manual switch configured to direct the stylus to shift to a selected mode.

63. The device of claim 51, further comprising a manual switch configured to direct the stylus to stop transmitting the first signal.

64. (canceled)

65. The device of claim 51, further comprising a second receiver configured to receive a second signal from the stylus, wherein the first signal and the second signal have different forms.

66. The device of claim 51, further comprising a second receiver configured to receive a second signal from the stylus, wherein the first signal and the second signal have different formats.

67. The device of claim 51, wherein the first receiver is further configured to receive a second signal from the stylus, wherein the first signal and the second signal have different forms.

68. The device of claim 51, wherein the first receiver is further configured to receive a second signal from the stylus, wherein the first signal and the second signal have different formats.

69. A method of receiving information from a stylus, comprising:
receiving a first signal indicating a status of the stylus;
determining a condition of the stylus; and
responding to the determined condition by directing the stylus to alter the first signal.

70.-79. (canceled)
